(19) United States
(12) Patent Application Publication
(10) Pub. No.: US 2001/0001857 A1
(43) Pub. Date: May 24, 2001

(54) METHOD OF LINKING DISPLAY IMAGES

(76) Inventors: LUKE KENDALL, MARRICKVILLE (AU); RICHARD LAM, WATERLOO (AU)

Correspondence Address: FITZPATRICK CELLA HARPER & SCINTO, 30 ROCKEFELLER PLAZA, NEW YORK, NY, 10112, US

(21) Appl. No.: 09/026,615

(22) Filed: Feb. 20, 1998

(30) Foreign Application Priority Data
Feb. 20, 1997 (AU) P05232

(51) Int. Cl. G06F 15/00

(52) U.S. Cl. 707/501

(57) ABSTRACT

A method of providing a hierarchical structure linking a plurality of images on a page. A frame is provided for each of the images, each frame including at least one link node. A link vector is then generated, linking a node on one frame with a node on another frame, thereby to create a child item to parent item relationship between images associated with the respective frames. The steps of node linking are repeated as desired until a family of child item to parent item relationships has been generated.

### FIELD OF THE INVENTION

The present invention relates to the linking of digital images for display and, in particular to the linking of captions, line-art (clipart) and digital images for facilitating the manipulation of images on an electronic display document.

### BACKGROUND ART

Electronic photo-albums have become increasingly popular in recent times. These electronic photo-albums typically take the form of a collection of images stored using a non-volatile memory device, from which a user can retrieve the image for displaying on a display device. Usually, the images are gathered in digital form, and may, for example, be scanned by an electronic scanner, down-loaded from the internet or produced by a digital camera, A collection of these images can be stored electronically to create an electronic photo-album, analogous to the traditional family photo-album which uses photographic prints.

Presently, electronic photo-albums take the form of a collection of images, a user of the album being able to associate a caption or brief description with each image. For example, a user can collect a series of family photographs of a wedding, whether from a digital video or still camera, and associate a caption such as the date and a brief description of the event with each image. If desired, an electronic photo-album can be reproduced from the memory device by a high quality output device, such as a high resolution colour printer, to produce an album substantially similar to a conventional photo-album.

However these electronic photo-albums do not provide a manner of efficiently grouping or manipulating images. Furthermore, current electronic photo-albums do not permit efficient manipulation of captions which may be associated with the images.

It is an object of the invention to overcome or at least ameliorate one or more of the disadvantages of the prior art.

### SUMMARY OF THE INVENTION

Accordingly, in a first aspect, there is provided a method of providing a hierarchical structure for manipulating at least one selected image of a plurality of images, said method comprising the steps of:

a) providing an image slot for each of said selected images;

b) constructing a bounding box for each said slot, wherein each of said bounding boxes is provided with at least one link node;

c) creating a link vector adapted to link a link node of one said bounding box to a link node of another said bounding box slot, wherein said bounding boxes are linked in a child item to parent item relationship;

d) repeating step c) until a desired family group is constructed.

In a second aspect, there is provided a method of manipulating at least one image of a plurality of images, said method comprising the steps of:

a) constructing a bounding box for each image of the plurality of images, wherein each of said bounding box is provided with at least one link node;

b) creating a link vector adapted to link a link node of a bounding box of one image to a link node of a bounding box of another image, wherein said one image is a child item and said other image is a parent item; and

c) repeating step b) until a desired family group is constructed; wherein

d) the manipulation of a parent item results in a manipulation of one or more child items.

In a third aspect, there is provided a method of providing a hierarchical structure linking a plurality of images on a page, the method including the steps of:

(a) providing a frame for each of the images, each frame including at least one link node;

(b) generating a link vector linking a node on one frame with another frame, thereby to create a child item to parent item relationship between images associated with the respective frames

(c) repeating step (b) until a desired family of child item to parent item relationships has been generated.

Preferably, the third aspect of the invention further includes the step of manipulating the frame of a child item to effect manipulation of the corresponding child item, wherein a related parent item is not manipulated by such manipulation of the child item.

In a particularly preferred embodiment, the third aspect of the invention further includes the step of manipulating the frame of a parent item to effect manipulation of the corresponding parent item, wherein related child items are correspondingly manipulated by manipulation of the parent item.

In a fourth aspect, the invention provides a computer apparatus including:

means for providing an image slot for each of said selected images;

means for constructing a bounding box for each said slot, wherein each of said bounding boxes is provided with at least one link node; and

means for creating a link vector adapted to link a link node of one bounding box slot to a link node of another bounding box slot, wherein the bounding box slots are linked in a child item to parent item relationship.

Preferably, in a computer apparatus according to the fourth aspect, each of the parent items may be manipulated, the manipulation of any parent item causing child items from the same family group correspondingly to be manipulated.

In a fifth aspect the invention provides a computer image processing system operable in accordance with the method of the invention.

In a sixth aspect, the invention provides a computer readable medium comprising instructions for implementing the method of the invention.

### BRIEF DESCRIPTION OF THE DRAWINGS

A preferred embodiment of the present invention will now be described with reference to the drawings, in which:

FIG. 1 shows hierarchical family group in accordance with the present invention;

FIG. 2 shows another example of a family group in accordance with the invention;

FIG. 3 illustrates a general purpose computer for implementing the invention;

FIG. 4 illustrates a link of a child item to a parent item of a family group in accordance with the invention;

FIG. 5 illustrates before and after examples of deleting a child item linked to a parent item;

FIG. 6 illustrates before and after examples of deleting a child item linked to a parent having a plurality of child items and re-linking the child items to the parent;

FIG. 7 is a schematic diagram showing an effect of moving a child item in a family group;

FIG. 8 is a schematic diagram showing an effect of resizing a parent item and scaling a link to one or more child items in a family group according to the preferred embodiment;

FIG. 9 is a diagram showing an effect of resizing a parent item and a constant offset link to one or more child items in a family group;

FIG. 10 illustrates before and after examples of rotating one or more child items under rotation of a family group; and

FIG. 11 illustrates before and after examples of rotating of a family group;

FIG. 12 is flowchart illustrating a method of creating a hierarchical structure according to the invention; and

FIG. 13 is a more detailed flowchart showing the steps in forming a link between a child item and a parent item, in accordance with the invention.

### DETAILED DESCRIPTION

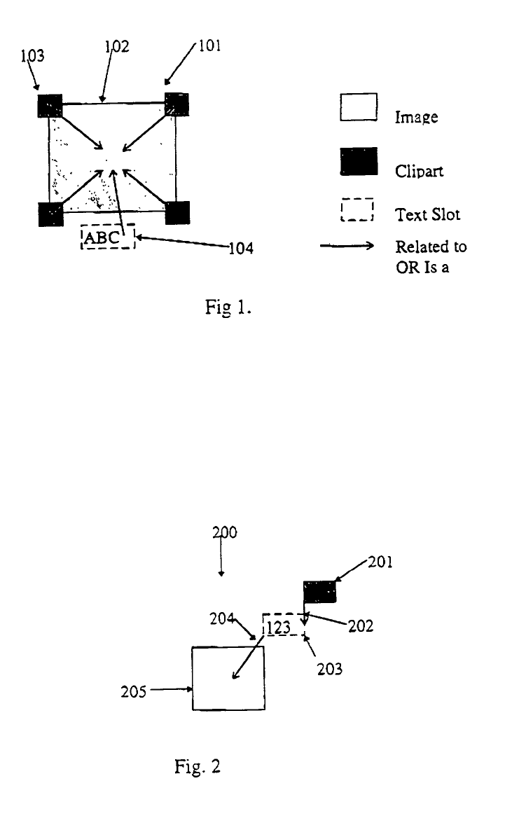

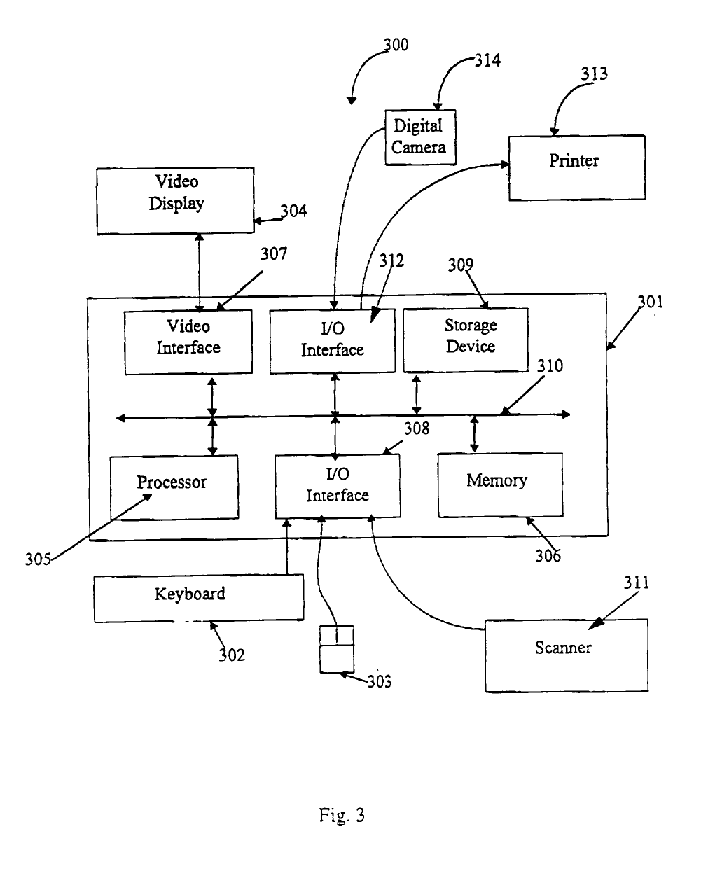

The examples shown in FIGS. 1 and 2 provide an overview of a preferred embodiment of the present invention. A family group 101 comprises a collection of one or more page items that link together such that the position of each item in the family group is relative to another page item of the group. Unless otherwise specified, a link is illustrated in the accompanying drawings by an open-ended arrow from one page item to another page item, whilst arrows that emanate from a drawing reference numeral are solid. A page item consists of any one of the following:

a text slot comprising text characters;

an image slot comprising one or more digital images including object-based images and/or pixel-based bit-map) images;

a clipart slot comprising computer generated images;

a family group itself comprising one or more page items; and

a frame and an associated image.

For example, a user may wish to produce an electronic photo-album of a relative's wedding. In this album the user can choose to: construct a family group by linking several images together according to a predetermined preference (eg. relating to the church scene); link captions and/or clipart to one or more images and generate several family groups; or link one or more family groups together.

Further, a text slot, an image slot and a clipart slot can be provided on an electronic page without the corresponding text characters, digital image and computer generated image occupying the respective slot and a content of each slot can be loaded after the slots are linked to a family group. Alternatively, slots or frames may simply be provided without being designated as text, a digital image or the like, the method of the invention being used to link the frames or slots together to form a family group.

Preferably, page items are linked together in a hierarchical structure, to form a family group, and a collection of family groups make up an electronic photo-album in accordance with the preferred embodiment of the present invention. In a hierarchical is structure a page item, forming part of a family group, is classified as a parent item or a child item depending on a link relationship between two or more page items of the group. Typically, the link relationship is that child items are linked to parent items according to a predetermined relative coordinate position. For example, FIG. 1 illustrates an image slot as a parent item 102 and linked to the parent are a plurality of children, in this example, four child items are designated as clipart slots 103 and one child item is designated as a text slot 104. A centre position of each child item of the example in FIG. 1, is defined relative to (or linked to) a centre point of the parent item 102. The relationship is such that if the parent item is moved, its children will follow accordingly.

Another example of a family group 200 is shown in FIG. 2, where a clipart slot 201 is linked 202 to a side of a text slot 203 so that the clipart slot 201 is a child item of the text slot (parent) 203. The text slot 203 is linked 204 to the centre of an image slot 205. In this example, the text slot 203 and clipart slot, together, form a child item of the parent image slot 205. FIG. 2 is also a simple example of a hierarchical structure, where a child item has at most one parent. The text slot 203 is the parent of the clipart slot 201 and the image slot 205 is the parent of a family group comprising the text slot 203 and the clipart slot 201. Conventionally, this type of hierarchical structure is often referred to as a tree structure. Typically, in a tree structure a first (parent) item has descendent items (children) and one or more of the descendent items are parents to further child items and so on. The first item of the tree structure typically has no parent and is termed the “root” (item) of the tree.

In the preferred embodiment of the present invention a tree structure of page items is a family group, and the root of the tree is a page item positioned on an electronic page document in accordance with an absolute coordinate system. The absolute coordinate system preferably has it's origin at the top left hand corner of the electronic page, with increasing positive coordinates from left to right and from top to bottom of the page. Preferably the root item of the family group is positioned using the absolute coordinate system, and other page items of the family group are positioned relative to their corresponding parent item. Hence each child item is positioned, on an electronic page document, using a relative coordinate system at a predetermined distance from the child item's corresponding parent. Preferably, a local origin of the relative coordinate system is located at an absolute coordinate position of the corresponding parent item and in the present embodiment, a top left corner of a bounding box of the corresponding parent item is the local origin of a child item. A plurality of such electronic pages together form a multiple page electronic photo album.

The invention may be practised using a conventional general-purpose computer system, such as the system 300 shown in FIG. 3, wherein the linking of page items into a family group is implemented as software executed on the computer system 300. The computer system 300 comprises a computer 301, input devices 302, 303 and a display device 304.

The computer 301 comprises at least one processor unit 305, a memory unit 306 which typically includes random access memory (RAM) and read only memory (ROM), input/output (I/O) interfaces including a video interface 307, and an interface 308 for a keyboard 302, a input digital scanner device 311 and a mouse (or joystick) 303. The storage device 309 can include one or more of the following devices: a floppy disk, a hard disk drive, a CD-ROM drive or similar non-volatile storage device known to those skilled in the art. Further, the general-purpose computer can have additional I/O interfaces 312 for such peripheral devices as a printer 313 and/or a photographic (video or still) camera 314 for down-loading images to the computer 301, The components 305 to 309 of the computer 301 typically communicate via an interconnected bus 310, and in a manner which results in a usual mode of operation of the computer system 300 known to those skilled in the relevant art. Examples of computes on which the embodiments can be practised include IBM-PC/ATs and compatibles, Sun Sparcstations or a like computer system.

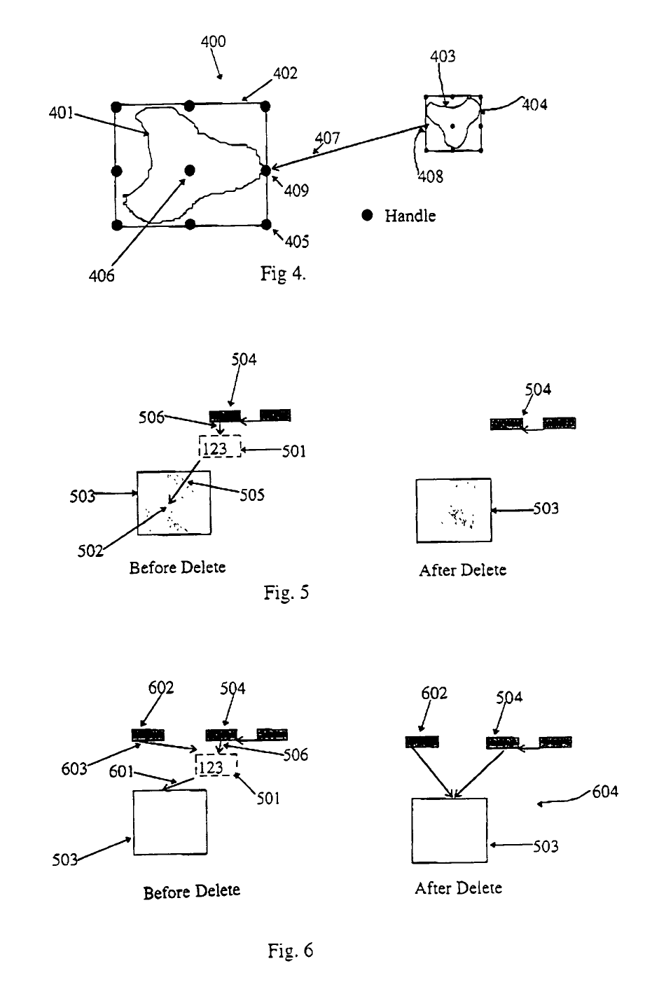

Referring now to FIG. 4 there is shown an example of linking of page items according to the preferred embodiment. Each page item comprises a bounding box, preferably rectangular in shape, which encompasses the page item. In the present embodiment, a bounding box further comprises a plurality of link nodes referred to herein as “handles” that can be used as linking and alignment points. Preferably, a handle is located at each corner of a bounding box, at each mid point of the edges of the bounding box and at the centre of the bounding box, For example, a first page item 401 of a family group 400 is enclosed by a first bounding box 402, and a second page 403 is enclosed by a second bounding box 404. The first bounding box, of the example in FIG. 4, comprises nine “handles” 405, including the centre handle 406 located at the geometric centre of the bounding box 402. Similarly, the second bounding box 404 also comprises nine handles. A link 407 (or vector) between one handle 408 and another handle 409 of two page items is shown in FIG. 4. Accordingly, the link 407 defines a relationship of the first page item as parent to the second page item as child. Hence, when making a link from a child to a parent, a vector is constructed from one handle of a child item to a handle of a parent item.

Operations on a Family group

Adding a page item to a family group can be performed by a user of the electronic photo-album, in an interactive mode by software running on a computer system. When adding a new page item to a family group, the user can determine which existing page item is to become a parent item of the new page item, and which handle of the new page item (child item) is to be linked to a handle of the parent item.

Further, the user can interactively break one or more links, or break and re-link page items to change relationships between page items. For example, a parent-child relationship can be changed by breaking a link between a child item and its corresponding parent, and re-linking the parent-child relationship with a new link, pointing in an opposite direction. In this way, the original child item becomes a parent of the what was originally the parent item.

FIGS. 5 and 6 illustrate two different way in which deletion of page items may be handled according to the invention. FIG. 5 shows a first embodiment, in which the links are configured such that deletion of one set of links does not cause relinking of remining links. In particular, the “Before Delete” example shows a frame in the form of a text slot 501 linked via link 505 to a centre handle 502 of another frame in the form of image slot 503. To a centre handle of the text slot 501 there is linked via link 506 a family group 504 comprising two clipart slots linked together. In this way, image slot 503 is a parent of text slot 501, which in turn is a parent of family group 504.

Deletion of the text slot 501 causes corresponding deletion of the link 505 to the image slot 503 (the parent). Furthermore, the link 506 from the family group 504 (child item) to the text slot 501 is also removed. As shown in the “After Delete” example, the result is the image slot 503 and the family group 504 remaining without any links between them, such that they do no longer form a family group. The image slot 503 is a separate page item to the family group 504, and has become a root item. In the present example, and after a page item has been deleted, each remaining (undeleted) page item not having a parent item becomes a root item.

FIG. 6 illustrates an alternative embodiment, in which deletion of an intermediate page item results in relinking of its parent and children to form a new hierarchical family structure. The “Before Delete” example shows a frame in the form of text slot 501 linked to a handle at a mid-point of an edge of the image slot 503. To a centre handle of the text slot 501 there is linked via a link 506 a family group 504 comprising two clipart slots linked together. A further clipart slot 602 is linked via link 603 from its bottom left corner handle to a top left corner handle of the text slot 501. The arrangement of the “Before Delete” example of FIG. 6 forms a single family group and after a deletion of the text slot 501 a new single family group is formed by re-linking the page items (602, 504) not deleted. The “After Delete” example in FIG. 6 shows re-linking of the clipart slot 602 and the family group 504 to the image slot 503 in accordance with the preferred embodiment. Preferably, this re-linking after deletion of a page item is an automated process, in which a user need only select whether or not a re-linking is to automatically occur following the deletion of a page item. The manner in which handles are chosen for a re-linking will typically be predetermined, and a preferred option for the present embodiment to use the same handle of a parent used by a deleted child.

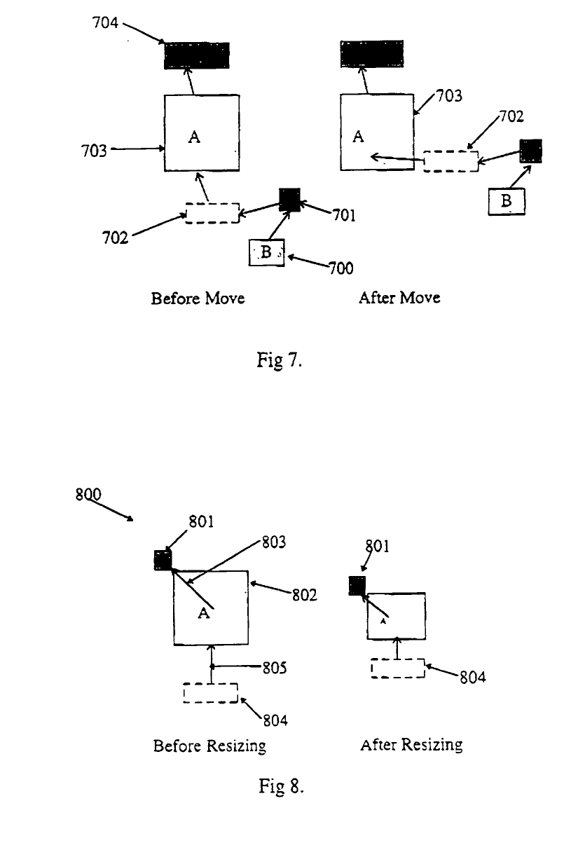

Turning to FIG. 7, moving a page item in a family group will move all children of the page item and their children's children, if any, by the same offset. However, a parent item will not be affected by a moving of a child item. For example, the before example of FIG. 7 shows an image slot (image B) 700 linked to a clipart slot 701, and in turn the clipart slot 701 is linked to a text slot 702. The text slot 702 is linked to an image slot (image A) 703 and “image A” is linked to another clipart slot 704. Moving the text slot 702 will move its child item, and comprises, at least for the present example, the clipart slot 701 and the image slot (image B) 700 but does not affect the position of the parent item of the text slot 702. An after example of moving the text slot is also shown in FIG. 7. Preferably, handles used to link page items before a move operation remain, and the same handle is used to link the page items after the move operation (ie. handles are invariant following a move operation).

Illustrated in FIG. 8 is a before and after example of the scaled resizing of a page item of a family group. The before example shows a family group 800 including a clipart slot 801 linked via a link 803 to an image slot 802. A text slot 804 is similalrly linked to the image slot 802 via link 805. As shown in FIG. 8, resizing the image slot 802 proportionately scales eachof the links 803, 805 associated with the image slot 802. Accordingly, the clipart slot 801 and the text slot 804 are moved proportionately with the resizing of the image item slot 802. Thus, resizing an page item of a family group affects both the links of the parent items and child item such that a relative position between the page item and corresponding parent and child items are resized (scaled) accordingly or the links are scaled accordingly.

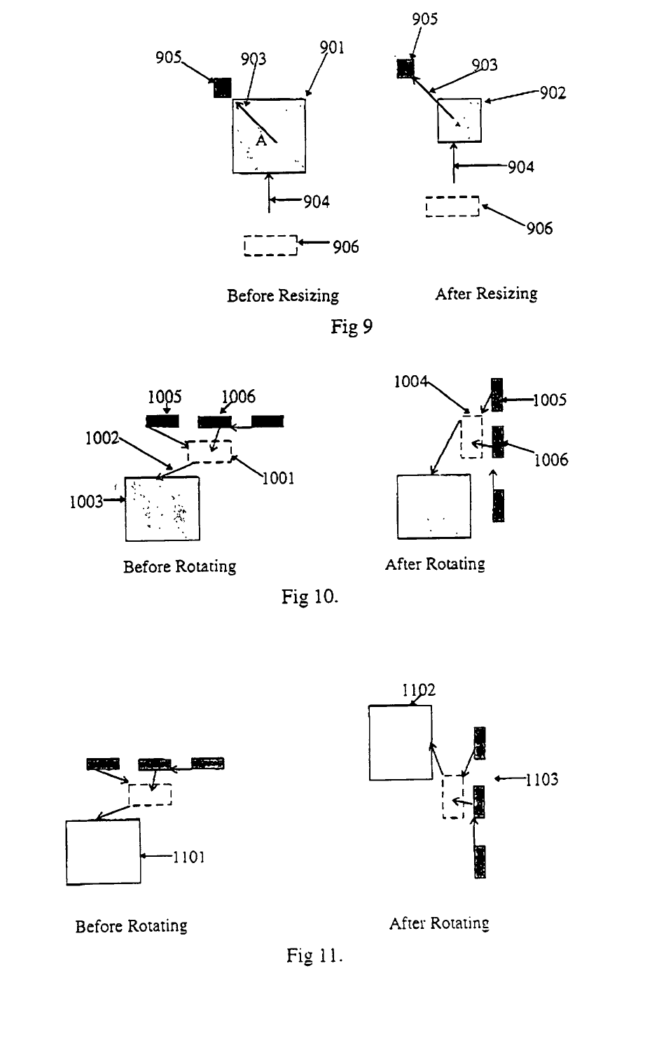

An alternative option to scaled resizing shown in FIG. 8 is constant offset resizing. Constant offset resizing, as illustrated in FIG. 9, refers to resizing a page item of a family group while maintaining a constant relative offset from the page item to a corresponding parent item or children items associated with the page item so resized. Before and after examples of constant offset resizing are shown in FIG. 9. An image slot 901 is resized to produce a resized image slot 902 of different area to the image slot 901 before resizing. A link 903 to a parent item 905 and link 904 to a child item 906 remains unchanged after the page item (image slot) 901 has been resized. In this example a constant offset between a resized page item and associated parent or children have been maintained. In each of the examples described above, when an image slot is resized, preferably, an aspect ratio of the image is maintained constant.

Turning to FIGS. 10 and 11, rotation of a page item of a family group causes corresponding rotation of its children by a substantially similar angle. However, this rotation does not affect any parent items. FIG. 10 shows before and after examples of rotation of a text slot 1001 by 90 degrees with respect to image slot 1003. The text slot 1001 is linked to the image slot 1003 via a link 1002. As shown in the “After Rotating” example, text slot 1001 is shown as a rotated text slot 1004. Children 1005 and 1006 associated with the original text slot 1001 have also been rotated, and maintain the same spatial relationship to each other and rotated text slot 1004 as they did in the “Before Rotating” example of FIG. 10. It will be appreciated that the 90 degree angle of rotation is intended to serve as an example only, and those skilled in the art would appreciate that other angle rotations are possible without departing from the scope and spirit of the invention.

FIG. 11 is a before and after example of rotating an entire family group by a predetermined angle.

To rotate an entire family group, a rotation is applied to a root item thereof. As described with reference to FIG. 10, rotating a page item will rotate all associated children and their children's children. Thus, rotating a root item of a family group will rotate the entire family group. In FIG. 11, the root item is an image slot 1101 and rotating the image slot 1101 results in a rotated image slot 1102 and rotation of all associated children 1103. During this procedure, there is no need to disconnect links between parents and children, as they are simply rotated along with the page items. As can be clearly seen in relation to both FIGS. 10 and 11, the links between the rotated page item and its children remain in precisely the same position relative to each other, and the same handles are used as linking points. However, although the linking points between the rotated page item and its parent are the same, the relative positions of the two are changed with relation to each other during the rotation.

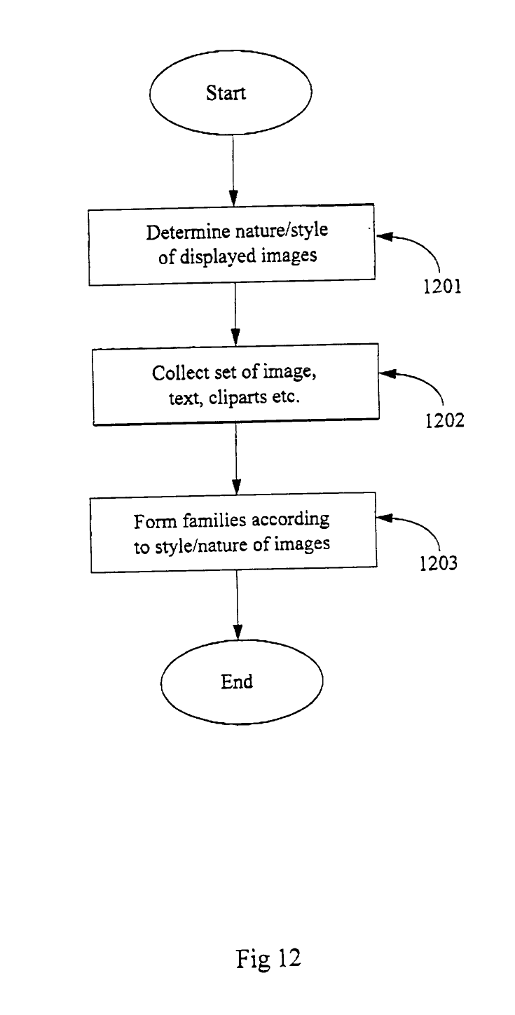

Turning to FIG. 12, there is shown a simplified flowchart of a method of implementing the invention. To begin with, the nature or style of a plurality of displayed images are assessed (1201), using known techniques. As a result of this determination, the images are grouped (1202) into sets, which are then formed (1203) into families. In this way, a suitable families are formed in a meaningful way, thereby improving the efficiency of image manipulation for a subsequent user.

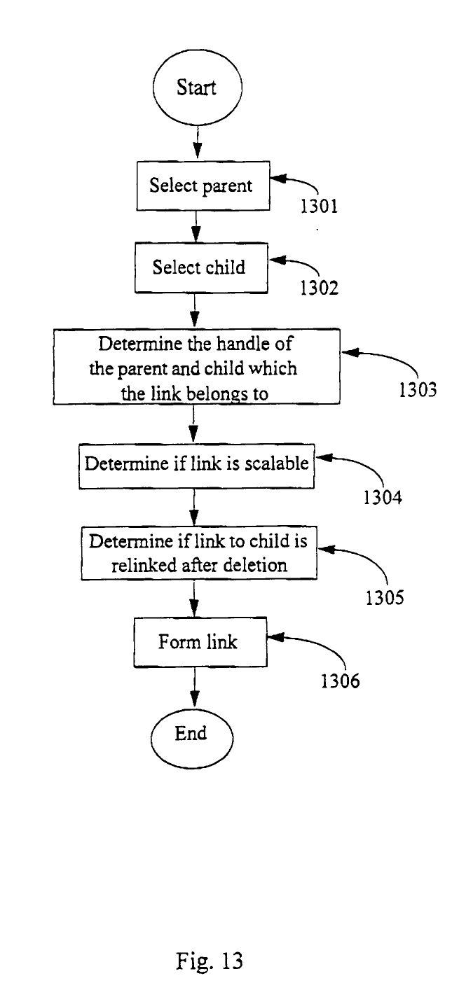

FIG. 13 is a detailed flowchart showing a method according to the invention for forming a child item to parent item link. The method shown may be implemented manually by a user, but may also be performed automatically, preferably in conjunction with the method illustrated in the flowchart of FIG. 12. Initially, a parent item (1301) and a child item (1302) are selected from a group of available images. Whilst the parent item is shown as being selected first, the order of selection is not critical. Given that there is more than one handle available for each image via its associated frame or bounding box, the handle for each end of the vector linking the parent and child items are selected (1303). It is then decided whether the link should be scalable (1304), and whether the link to the child is relinked after deletion (1305). Finally, the link is formed (1306).

The invention may also take the form of a software medium (not shown) bearing instructions for implementing the invention. The medium may take the form of, for example, known media such as CD-ROM or floppy disks. However, any suitable medium may be used.

Whilst the invention has been described with reference to a number of specific example, it will be appreciated by those skilled in the art that the invention may be embodied in many other forms.

What is claimed is:

1. A method of providing a hierarchical structure for manipulating one or more of a plurality of images, said method comprising the steps of:
a) providing an image slot for each of said selected images;
b) constructing a bounding box for each said slot, wherein each of said bounding boxes is provided with at least one link node;
c) creating a link vector adapted to link a link node of one bounding box slot to a link node of another bounding box slot, wherein the bounding box slots are linked in a child item to parent item relationship;
d) repeating step c) until a desired family group is constructed.

2. The method as recited in claim 1, wherein said image slot includes a text slot, a clipart slot or a digital image slot.

3. The method as recited in claim 2, wherein said text slot comprises substantially text characters.

4. The method as recited in claim 2, wherein said clipart slot comprises substantially computer generated images.

5. The method as recited in claim 2, wherein said digital image slot comprises substantially bitmap digital images.

6. The method as recited in claim 1, comprising the further step of manipulating a child item bounding box slot such that the manipulating does not manipulate a parent item bounding box.

7. The method as recited in claim 1 or claim 6, comprising the further step of manipulating a parent item which, for predetermined manipulates, result in a manipulation of a child item.

8. A method of manipulating at least one of a plurality of images, said method comprising the steps of:
a) constructing a bounding box for each image of the plurality of images, wherein each of said bounding box is provided with at least one link node;
b) creating a link vector adapted to link a link node of a bounding box of one image to a link node of a bounding box of another image, wherein said one image is a child item and said other image is a parent item; and
c) repeating step b) until a desired family group is constructed; wherein
d) manipulation of a parent item results in a manipulation of one or more child items.

9. The method as recited in claim 8, wherein said manipulation includes a rotation, a translation, a delete, a re-linking of link vectors, a resizing and/or combinations of the manipulations.

10. A computer apparatus operable according to the method of claim 1 or claim 8.

11. A computer image processing system operable according to the method of claim 1 or claim 8.

12. A computer readable medium comprising instructions for implementing the method of claim 1 or claim 8.

13. A method of providing a hierarchical structure linking a plurality of images on a page, the method including the steps of:
(a) providing a frame for each of the images, each frame including at least one link node;
(b) generating a link vector linking a node on one frame with another frame, thereby to create a child item to parent item relationship between images associated with the respective frames
(c) repeating step (b) until a desired family of child item to parent item relationships has been generated.

14. A method according to claim 13, further including the step of manipulating the frame of a child item to effect manipulation of the corresponding child item, wherein a related parent item is not manipulated by such manipulation of the child item.

15. A method according to claim 13, further including the step of manipulating the frame of a parent item to effect manipulation of the corresponding parent item, wherein related child items are correspondingly manipulated by manipulation of the parent item.

16. A method according to claim 15, wherein the corresponding child items are correspondingly manipulated only for predetermined manipulations of their related parent.

17. A method according to claim 13, wherein a child item may be a parent item for a further child item.

18. A method according to claim 13, wherein one or more of the frames is designated as a text frame, a clipart frame, or a digital image frame.

19. A method according to claim 13, wherein the frame includes a bounding box for bounding the corresponding image.

20. A method of manipulating at least one of a plurality of images, said method including the steps of:
a) generating a bounding box for each of the plurality of images, each bounding box including at least one link node;
b) creating a link vector linking a link node of a bounding box of one image to a link node of a bounding box of another image, thereby to establish one image as a child item and the other image as a parent item; and
c) repeating step b) until a desired family group is constructed; wherein manipulation of a parent item results in a manipulation of one or more child items within the family group.

21. A method according to claim 20, wherein said manipulation includes a rotation, a translation, a delete, a re-linking of link vectors, a resizing, or any combination of those manipulations.

22. A computer apparatus including:
means for providing an image slot for each of said selected images;
means for constructing a bounding box for each said slot, wherein each of said bounding boxes is provided with at least one link node; and
means for creating a link vector adapted to link a link node of one bounding box slot to a link node of another bounding box slot, wherein the bounding box slots are linked in a child item to parent item relationship.

23. A computer apparatus including:
(a) means for providing a frame for each of the images, each frame including at least one link node; and
(b) means for generating a link vector linking a node on one frame with another frame, thereby to create a child item to parent item relationship between images associated with the respective frames; wherein
the computer apparatus is configured to repeat step (b) until a desired family of child item to parent item relationships has been generated.

24. A computer apparatus according to claim 22 or claim 23, wherein each of the child items may be manipulated, the manipulation of any child not affecting the corresponding parent item.

25. A computer apparatus according to claim 22, wherein each of the parent items may be manipulated, the manipulation of any parent item causing child items from the same family group correspondingly to be manipulated.

26. A computer image processing system operable according to the method of claim 13 or claim 20.

27. A computer readable medium comprising instructions for implementing the method of claim 13 or claim 20.
